(19) United States
(12) Patent Application Publication
(10) Pub. No.: US 2024/0105008 A1
(43) Pub. Date: Mar. 28, 2024

(54) SYSTEM AND METHOD FOR PLAYER SELF-SERVICE CASINO JACKPOT PROCESSING

(71) Applicant: Everi Payments Inc., Austin, TX (US)

(72) Inventors: Adam Fong, Las Vegas, NV (US); Justin Nelson, Mill Valley, CA (US); Ryan May, Las Vegas, NV (US)

(21) Appl. No.: 18/527,612

(22) Filed: Dec. 4, 2023

Related U.S. Application Data
(63) Continuation-in-part of application No. 17/962,274, filed on Oct. 7, 2022.
Application No. 17/962,274 is a continuation-in-part of application No. 17/723,682, filed on Apr. 19, 2022, now Pat. No. 11,893,859.
(60) Provisional application No. 63/178,109, filed on Apr. 22, 2021.

(51) Int. Cl. G07F 17/32; G06Q 20/02; G06Q 20/36

(52) U.S. Cl. CPC G07F 17/3258; G06Q 20/02; G06Q 20/36; G07F 17/3237; G07F 17/3255

(57) ABSTRACT

A method and system facilitate self-service processing of a jackpot win by a player of a gaming machine. A jackpot processing system receives notification of a jackpot win, generates jackpot processing information including an amount to be awarded to the player, such as a jackpot amount less offsets thereto, and generates and sends a message to the player's mobile communication device. The message allows the player to confirm the jackpot processing information and provide necessary confirmations, such as a signature. The jackpot processing system generates a jackpot win record, may generate one or more associated win forms, and facilitates payment of the award amount to the player.

### RELATED APPLICATION DATA

This application is a continuation-in-part of Ser. No. 17/962,274, filed Oct. 7, 2022, which is a continuation-in-part of U.S. application Ser. No. 17/723,682, filed Apr. 19, 2022, which claims priority to U.S. Provisional Application Ser. No. 63/178,109, filed Apr. 22, 2021. Each of these prior applications is incorporated herein by reference in its entirety.

### FIELD OF THE INVENTION

The present invention relates to casino gaming, including casino game awards such as jackpots.

### BACKGROUND OF THE INVENTION

Casino winnings may be paid in different manners. For example, relative to a gaming machine which is capable of dispensing monetary winnings or a monetary value ticket (often referred to as a cashless gaming ticket) or the like, the winnings may be directly awarded and then dispensed to the player. As one example, a player might win $500. Those winnings might be associated with a monetary value credit meter at the gaming machine. The player might then elect to cash-out that balance, including the winnings, as either coins dispensed at the machine or, in most modern gaming machines, a monetary value ticket which can be redeemed.

A casino may desire, however, to validate larger jackpots. In that event, the gaming machine may report a jackpot win to the casino gaming system. However, the jackpot winnings may not be awarded until casino personnel validate the win.

In addition, some jurisdictions like the U.S. require that a casino report (to the Internal Revenue Service) player winnings over certain thresholds. For example, relative to a gaming machine, this threshold is currently $1200 in the U.S. In a situation where a player wins more than $1200.00, the casino will generally require the player to complete a jackpot winnings form which the casino can then use to report the jackpot win to the Internal Revenue Service of the U.S. government. This form, called a W2G in the U.S., includes information regarding the amount of the win and the player's identity (such as their name and social security number and the like).

One problem for casinos is that the player must later submit a copy of the tax reporting form with their tax return. Thus, a casino must generally provide a copy of the tax reporting form to the player, such as in the form of a receipt. However, players often lose their copy of the form. At tax filing time (usually April 15 of each year in the U.S.), players often bombard casinos with requests for copies of their tax reporting forms.

Further, other problems exist with the existing process for processing jackpots. For example, while a jackpot win is validated and paid, the gaming machine is generally taken out of service, which is undesirable. In addition, validation of the win and preparation of the win forms is often hindered, such as because the player does not have authenticating documents, such as a verifiable ID.

Also, in situations where the casino desires to directly pay a jackpot to a player (as opposed to forcing the player to travel to a casino cage to obtain their winnings), the casino must supply customer service personnel with sufficient funds to pay the player. Given the number of jackpots that a casino may need to pay in a day, this creates complexities with keeping the customer service personnel sufficiently funded, but at the same time ensuring that the funds are trackable and remain secure.

Solutions to these and other problems are difficult in part because casinos are highly regulated and utilize complex electronic systems. For example, the gaming machines which award jackpots are electronic machines which are linked to back-end casino management systems which monitor activities at the gaming machines. The gaming machines and/or casino management system may then also communicate with a plurality of other systems, such as cashless wagering systems and loyalty systems, such as which are used to track and report monetary transactions. Thus, solutions to the above-stated problems need to also address technical issues and limitations associated with these existing electronic casino devices and systems.

### SUMMARY OF THE INVENTION

Embodiments of the invention include, but are not limited to, methods and systems for processing a jackpot won by a player of a gaming machine.

One embodiment of the invention comprises a system and method for player self-service processing of a jackpot win. In one embodiment, a jackpot processing system receives a notification of a jackpot win by a player of a gaming machine. The jackpot processing system generates jackpot processing information, such as including an amount to be awarded to the player. The amount to be awarded to the player may comprise an amount of the jackpot, less offsets thereto, which offsets may comprise amounts owed by the player (such as for child support, unpaid casino markers, etc.). The jackpot processing system is configured to generate and send a message to the player's mobile communication device which allows the player to confirm the jackpot processing information and provide necessary confirmations, such as a signature, such as by clicking on a hyperlink provided in the message which causes the jackpot processing information to be displayed at the player' mobile communication device. The jackpot processing system generates a jackpot win record, may generate one or more associated win forms, and facilitates payment of the award amount to the player.

Further objects, features, and advantages of the present invention over the prior art will become apparent from the detailed description of the drawings which follows, when considered with the attached figures.

### DESCRIPTION OF THE DRAWINGS

FIG. 1 is a diagram of a system in accordance with an embodiment of the invention;

FIG. 2 is a diagram of a system in accordance with another embodiment of the invention; and

FIG. 3 is a flow diagram of embodiments of a method of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention include, but are not limited to, methods and systems for processing jackpots, including integrating jackpot processing with other features such as financial systems which track player markers and other player obligations, and particularly a method and system for player self-service processing of a jackpot.

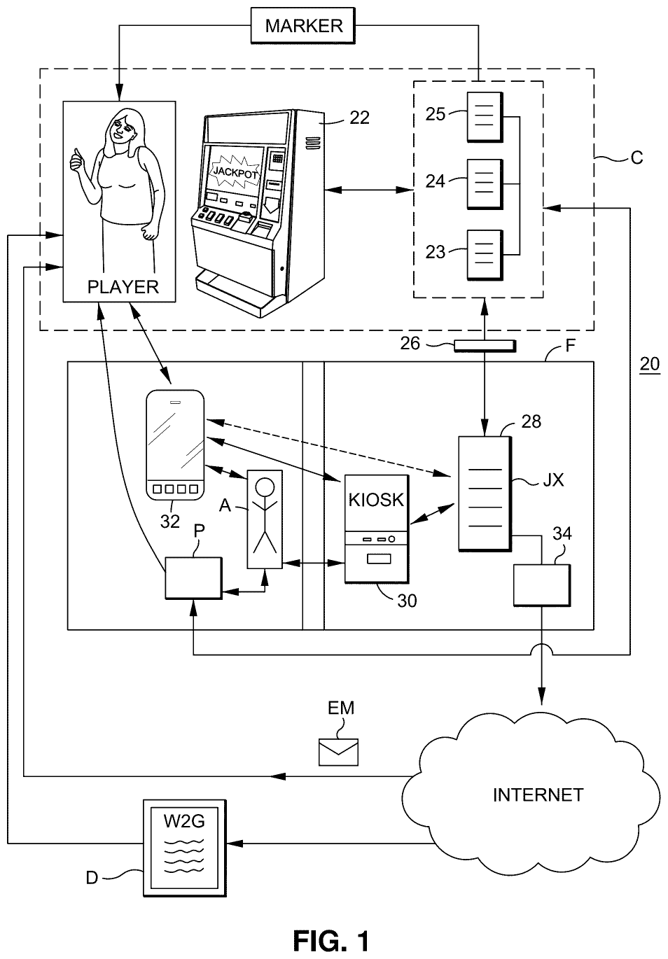

FIG. 1 illustrates one embodiment of the invention, which comprises a system 20. The system 20 may be referred to as a gaming system. As noted below, portions of the system might belong to or be operated by a casino (or the owner thereof) or entities other than a casino, and might be on-site or off-site as to the casino. In one embodiment, the system 20 may comprise elements associated with a casino, while other elements might be associated with third parties, such as a casino vendor or financial processor.

As indicated, a casino C may include one or more devices and/or systems and may be associated with one or more physical locations. In one embodiment, the casino C may include one or more gaming devices 22. Such gaming devices 22 may have various forms and be configured to present a wide variety of games. For example, the gaming devices 22 might comprise “slot” type gaming machines (having mechanical or video-simulated reels), video poker gaming machines, or other types of gaming machines which are now known or later developed. In general, the gaming devices 22 are preferably configured to present one or more games (generally games of chance or games that include a skill component but which are still predominantly games of chance), such as in exchange for the placement of a wager.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits). The awards might comprise, for example, awards of monetary value credits. Awards of a large size may be referred to as a “jackpot” award. In one embodiment, smaller awards might be awarded to the player as monetary value credits which are associated with a monetary value credit balance at the gaming machine. The player may be permitted to cash-out those credits, such as to a monetary-value ticket which the player can redeem at a kiosk or cashier station for cash (e.g. coins or currency) or as monetary value associated with a gaming account, bank account or the like. However, as indicated herein, jackpots might be processed in other manners.

The gaming device 22 might be configured as a stand-alone device (such as where the one or more games are presented by execution of machine-readable code stored in a memory of the gaming device by a processor or controller of the gaming machine) or as a server-based device (e.g. where certain information or instructions is generated remotely, such as by a gaming server, and is transmitted to the gaming device) for presenting games as Class III games (as defined by the U.S. Indian Gaming Regulatory Act) or as a server-based device for presenting games as Class II games (as defined by the U.S. Indian Gaming Regulatory Act). Presentation of the one or more wagering games may be facilitated by various peripheral devices of the gaming device 22, such as player input devices (a monetary value acceptor such as a bill validator, a ticket reader, a card reader, etc.), one or more buttons, a touch-screen, etc., and various output devices (one or more video displays, lights, speakers, ticket printers, etc.).

The gaming devices 22 might comprise other than gaming machines, and might comprise, for example, gaming tables or other gaming devices. For example, the gaming devices 22 might comprise gaming tables at which card games, dice games, roulette or other games are presented. A casino may have numerous such gaming devices 22, such as located on a casino floor or in other locations.

Referring still to FIG. 1, the casino C may include one or more central casino systems, which systems may include one or more servers and/or other devices for implementing casino-related functionality. For example, the casino C might include a management system or accounting server 23, a loyalty server 24 and a central credit server 25. These servers 23, 24, 25 may each comprise a computing device which comprises at least one processor for receiving information, processing information or executing code or software, and generating an output, such as control instructions. The casino servers 23, 24, 25 may also include means for storing information or instructions. Such means may comprise one or more memory devices. Such might comprise RAM, ROM (including EPROM, EEPROM, PROM) or other devices now known or later developed. In one embodiment, the servers may comprise or be in communication with one or more mass data storage devices, such as one or more hard drives or the like.

The casino servers 23, 24, 25 preferably also include at least one communication interface, by which it may receive and transmit information. The communication interface(s) may permit communications in accordance with various protocols (TCP/IP, 802.11xx, etc.) and in various forms and over various types of links (wired and/or wireless).

The casino servers 23, 24, 25 might actually comprise a system or network of a plurality of elements or devices. For example, the servers might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the server, such as to change operator settings and the like. The casino servers might also comprise a router and one or more separate computing devices. The functions of the various computing devices might be segregated (including by executing different modules of software which implement different features/functions).

The one or more gaming devices 22 are preferably in communication with the one or more casino servers 23, 24, 25 at one or more times. For example, the gaming devices 22 and the one or more casino servers 23, 24, 25 may be linked via one or more communication links. These communication links may be wired and/or wireless and may be dedicated, shared, part of a LAN, WAN or other network, such as an internal casino network.

The casino management system/accounting server 23 may be configured to implement accounting and/or ticketing functionality. In such a configuration, the gaming devices 22 may communicate with the accounting server 23, such as when seeking to print a monetary value ticket upon a cash-out request of a player (such as to create a ticket record and associated amount), or when a player seeks to redeem a monetary value ticket at the gaming machine (such as to validate the ticket and its amount). The accounting server 23 may, for example, generate and maintain records of monetary value tickets, including their amounts, whether they have been cashed-out, etc., and/or may perform other functionality, such as general accounting functionality (tracking and reconciling monetary value provided to the gaming devices 22, amounts wager, amounts won, amounts cash-out, etc.). The casino management system/accounting server 23 may also track funds activity at the gaming machines, including amounts associated with the gaming machines, amounts wagered and won, and may also effectuate transfer of funds to gaming machines.

The loyalty server 24 may also implement player loyalty functionality. For example, the gaming devices 22 may communicate with the loyalty server 24 to report player activity. The loyalty server 24 may maintain one or more player accounts, such as player loyalty accounts with game play information and loyalty awards.

The central credit server 25 may also implement player credit and/or monetary account functionality, such as a player wagering account for funding wagering and credit functionality, such as issuance of credit to the player. Such credit might comprise, for example, a casino marker. A casino marker comprises a negotiable instrument that represents an amount of credit given to the player (and thus debt by the player to the casino). The central credit server 25 may thus track markers which are outstanding to individual players, including amounts of credit extended to the players and associated terms, such as redemption periods and terms of the credit. While this functionality may be implemented by a casino, it may also be implemented by third party providers, such as a financial provider as described below.

The one or more casino servers may also implement game functionality. For example, the gaming devices 22 may communicate with the casino servers, such as to obtain game information, including game outcome information, to facilitate progressive jackpots or other gaming functionality.

As illustrated in FIG. 1, the system 20 preferably includes a financial system F. Elements of this system may be operated by an entity which is separate from the casino and one or more of the elements of the financial system F might be located at the casino or be remote therefrom. In other embodiments, financial system F might be part of the casino C, including being operated by the casino.

In one embodiment, the financial system F comprises one or more financial servers 28 (which may also be referred to as a jackpot processing server or the like), one or more kiosks 30, and one or more mobile transaction devices 32. In general, the financial server 28 may be configured to facilitate various requested financial transactions. The financial system F may include one or more databases which are configured to store information.

The kiosks 30 may have various configurations. In one embodiment, the kiosk 30 comprises a housing, one or more devices for receiving player input and/or displaying or otherwise providing information to a player, and at least one credit dispensing mechanism. The information input/output devices may include, for example, an electronic touch-screen video display. Other input/output devices may include one or more push-buttons, keypads, keyboards and/or other elements. The credit dispensing mechanism may comprise, but it not limited to one or more of: a currency dispenser, a coin dispenser, a ticket or other media dispenser (such as a magnetic card dispenser), or a media writer (such an RFID encoder or the like).

In one embodiment, the kiosk 30 includes at least one processor for executing machine readable code or software, and at least one memory device for storing machine readable code or software for execution by the processor. In one embodiment, the kiosk 30 includes at least one communication interface, such as for establishing a communication link with one or more other devices, such as the financial server 28. The kiosk 30 is preferably located within the casino C, such as where a plurality of kiosks 30 are located about the casino floor for access by players and/or attendants, as described below.

The mobile device 32 may comprise, for example, a tablet, but might also comprise a PDA or phone, or comprise a special-purpose device which is configured to implement the functionality herein. The mobile device 32 preferably comprises a housing, at least one display device (such as a video display), at least one user input device (such as one or more buttons, a touch screen, etc.), a processor, a memory, and a communication interface. Preferably, the communication interface supports or enables wireless communications. The memory may store machine-readable code which, when executed by the processor, causes the mobile device 32 to implement the functionality herein. In some instances, that code may comprise, for example, an “application” which is stored and runs on the mobile device 32. In other embodiments, the mobile device 32 may be configured to implement a web browser which causes the mobile device 32 to implement the functionality herein when the mobile device 32 is in communication with the financial server 28 (or other server/device). As described below, the mobile device 32 may be operated by a casino attendant A and may include various security elements (secure logins, etc.).

The financial server 28 is preferably configured to communicate with one or more aspects of the casino system C, such as one or more of the casino servers 23, 24, 25. In one embodiment, the casino servers 23, 24, 25, may run software which is different from, or is not integrated with, the software of the financial server 28. In such a configuration, the financial server 28 and the one or more casino servers 23, 24, 25 may communicate through one or more interfaces 26. These interfaces may comprise application program interfaces (APIs) which allow the servers to communicate with one another, such as by making “calls” to the other system for information, such as described below. As one example, the financial system F might comprise a server running Jackpot Xpress® from Everi Payments, Inc. of Las Vegas, Nevada. The casino might utilize a casino management system from a third party, such as IGT Advantage® from International Game Technology of Reno, Nevada. In that event, an API may be required for the Jackpot Xpress system to communicate with the IGT Advantage system.

In one embodiment, the financial system F is configured to communicate with one or more external devices or networks. For example, the financial system F may communicate with the Internet, and thus individual players, an external banking network, etc.

In one embodiment, as described below, the financial system F may include an email server 34. The email server 34 might be implemented in various manners. In one embodiment, it is implemented separately from the financial server 28, such as via a different computing device. The email server 34 may, for example, be segregated from the financial server 28 or other aspects of the financial system F or casino system C, including by one or more firewalls.

Additional aspects of the system 20 (including the configuration of machine-readable code or “software” which is executable by the processors of the various devices of the system 20) will be appreciated from examples of use thereof as described below.

One aspect of the invention is the processing of a jackpot win, including determining if the player has an outstanding marker (or other casino payment obligation), in which case, an option may be provided to credit all or part of the jackpot win to payment of the player's outstanding markers.

In one embodiment, a notification of a gaming machine jackpot is reported and/or received. As one example, a player may play a gaming device 22 such as that illustrated in FIG. 1. The player may obtain a winning game outcome. The winning outcome and/or associated award may be reported, such as by the gaming device 22 to one of the casino servers 23, 24, 25. If the winning game outcome has an award over a designated amount, then either the gaming device 22 and/or casino server 23, 24, 25 may detect or flag the outcome or award as requiring secondary validation, reporting or the like.

In one embodiment, the jackpot event is reported from one of the casino servers 23, 24, 25 to the financial server 28. Casino personnel may also be alerted to the jackpot win, such as by one of the casino servers 23, 24, 25 and/or the financial server 28. An attendant A may obtain a mobile processing device 32 and travel to the gaming device 22 that the player is playing. The attendant A may log into the device and then obtain information about the jackpot award. This information may be provided to the mobile processing device 32 from the financial server 28.

The information may include information regarding the player, or the attendant may collect that information from the player. For example, a player might provide an ID, a player loyalty card or account number, and/or name or other identifying information.

The player information may be used to determine whether the player has any outstanding credit obligations to the casino, such as outstanding/unpaid markers. In one embodiment, for example, the mobile processing device 32 may send a request to the casino credit server 24 (directly, through the financial server 28 or the like) to check whether the player who has won the jackpot has outstanding credit. This request preferably includes player identity information.

The request is used to poll the casino credit server 24 for outstanding credit obligations of the player. Such may comprise, for example, one or more markers. As indicated above, the request may pass through an API which allows the requesting system or device (such as the financial server 28 or mobile processing device 32) to communicate with the casino credit server 24.

In such event, information regarding the one or more outstanding credit obligations may be transmitted back to the mobile processing device 32 and might be displayed to the attendant A by an interface thereof. The attendant may be alerted to the number of credit obligations or markers, the amount of outstanding credit which the player is obligated to repay, etc. In another embodiment, a “marker” or “other” field might be displayed on the interface, thus alerting the attendant to the existence of outstanding credit and the option of crediting payment thereto.

So alerted, some or all of the amount of the jackpot which has been won by the player might be credited to the credit obligations, such as to pay them down or pay them off. In one embodiment, the attendant may seek player authorization for such payment. In other embodiments, the repayment from the jackpot may be automatic (e.g. without regard to whether the player desires to use the jackpot funds to pay down or pay off the credit obligations). In some embodiments, the attendant may input an amount (such as $XXX.YY) of the jackpot to be credited. In the case of multiple outstanding markers or other lines of credit, the attendant might be permitted to enter different amounts to be credited to the different markers or lines, or the markers or lines or credited might be credited from largest outstanding amount to smallest, oldest to newest, etc. In this regard, numerous required or optional rules may be implemented. For example, markers generally have payment terms which include a date by which the marker must be repaid. In one embodiment, if the marker is outstanding, but not past its repayment deadline, jackpot funds might optionally be used to pay the marker. On the other hand, if the marker is past its payment deadline and remains unpaid, jackpot funds may automatically be deducted and applied to payment of the marker.

When jackpot funds are credited to an outstanding marker or other line of credit, one or more transaction records may be created and linked to the jackpot. The records might be associated with the jackpot processing server 28 and/or transmitted to one or more of the casino servers 23, 24, 25, such as the casino credit server 25 to indicate the payment towards the marker or other casino credit, and/or to the accounting server 23, such as to reconcile the jackpot win at the machines to payments to the player's marker(s) and/or to the player.

Further, jackpot processing forms may be completed in relation to the transaction. For example, one or more jackpot processing forms may be displayed to the attendant A. These forms may be transmitted to the mobile processing device 32 and/or reside on the device, where those forms are preferably auto-populated with information which is stored by or obtained by the financial server 28 (either directly or as gathered from one or more of the casino servers 23, 24, 25). For example, the forms may include a W2G form which is populated with information regarding the player and the amount of the winnings (the information regarding the amount of the winnings and the player may be obtained, for example, by the financial server 28 from the casino server 23, 24, 25, including based upon the player's casino rewards account). Alternatively, or in addition, the attendant may manually gather information from the player or have the player enter the information into the mobile processing device 32 in order to complete the required forms (these forms may include government required reporting forms, casino release forms or other documents). For example, if the player does not have a player tracking account, the attendant may need to obtain the player's identity information directly.

In one embodiment, once the forms are complete, the attendant captures the player's signature (directly onto the forms or for association with the forms). This may comprise having the player sign via a touchscreen of the mobile processing device 32. The completed form(s) or associated information is then transmitted from the mobile processing device 32 back to the financial server 28. The financial server 28 may store the completed forms, such as in association with one or more transaction records, may transmit the forms to the casino, and/or may transmit the forms to the appropriate authorities (such as the IRS). Also, once the forms have been completed, if the jackpot is a ‘hand pay’ jackpot, the attendant may be notified that the jackpot can be paid or issued.

If not already done, the financial server 28 preferably collects personal information regarding the player. This information may be obtained from one or more of the casino servers 23, 24, 25, such as from a player tracking account for the player. Alternatively, the information might be obtained from the player, such as based upon information that the player provided to the attendant and which was input to the mobile processing device 32. This information may comprise one or more of the player's name, address, phone number, email address, social security number and the like.

In one embodiment of the invention, one or more jackpot-related forms are made available to the player. Most preferably, the one or more forms are made available to the player in a secure manners. For example, the documents might be made available for download D, by emailing EM, etc., including as described in U.S. Pat. No. 11,030,853 and U.S. patent application Ser. No. 17/339,471, filed Jun. 4, 2021, both of which are incorporated herein by reference in their entirety.

If the player has remaining jackpot funds after application of the jackpot funds to repay such casino credit obligations, the player may be paid the remaining winnings. Such winnings may be paid from a pouch P of the attendant, such as in currency form. In other embodiments, the attendant might access funds from the kiosk in order to pay the player. Of course, the player might be paid in other manners, such as with a receipt, ticket or the like which the player may redeem at a cashier cage. In other configurations, remaining funds may be directed to a player's casino account or wallet (such as Everi Payment Inc.'s CashClub Wallet™ product), or even the player's bank account.

While in one embodiment of the invention an attendant uses a mobile processing device 32 in order to process the jackpot, the principles of the invention (including checking whether the player who has won the jackpot has an outstanding casino credit obligation) may be applied in other manners. For example, in one embodiment, an attendant A might input player information into a kiosk, workstation or the like in order to check whether the player has an outstanding credit obligation. In another embodiment, the financial server 28 may receive information regarding a jackpot win, including player information. The financial server 28 might then communicate with the one or more casino servers 23, 24, 25 to determine whether the player has an outstanding credit obligation. If so, the financial server 28 may so notify the attendant A and the attendant A may confirm that the player at the gaming device 22 matches the player identified by the system, and thus that the casino credit obligation validly belongs to the player.

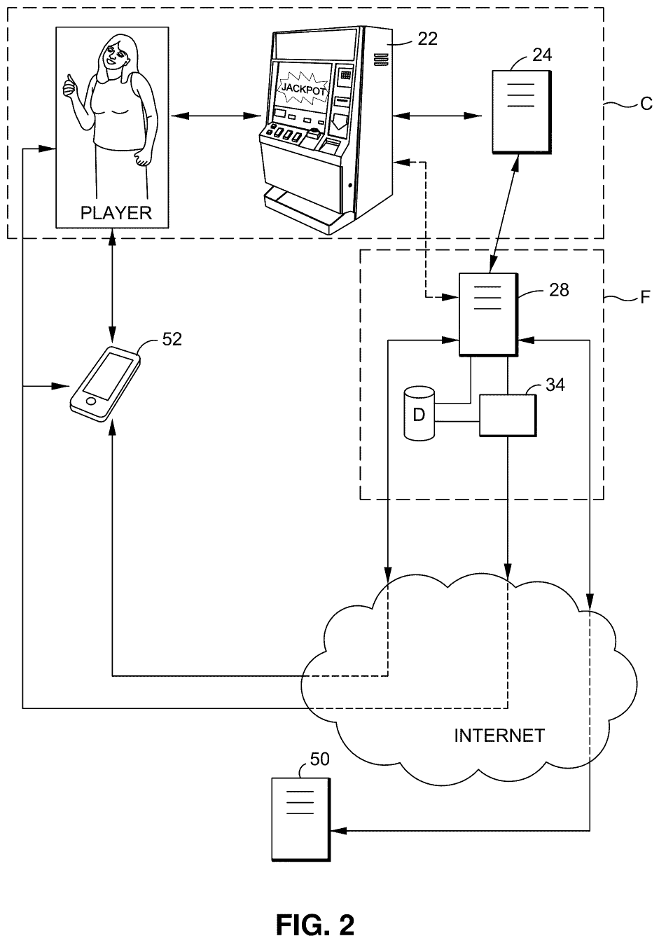

Additional aspects of the invention will be described with reference to FIG. 2.

As noted above, in one embodiment, the financial server 28 may receive information regarding an amount of a jackpot won at a gaming machine 22. The financial server 28 may also determine one or more amounts to deduct from the amount of the jackpot. These amounts might comprise, for example, tax withholdings and/or an amount of an outstanding marker, as detailed above.

However, the amounts to be deducted from the amount of the jackpot might include a tip, a child support obligation, or other outstanding or unpaid taxes. For example, as illustrated in FIG. 2, the financial server 28 may communicate with one or more external servers 50 or systems. Such a server 50 or system might be associated with, for example, a local, state or federal tax authority, a court system, or the like, which server 50 or system may identify amounts owing by a player, such as in response to a query from the financial server 28. For example, the financial server 28, upon obtaining information about the player who won the jackpot, may send information about the player (Driver's License ID #, full name, etc.) to such a server 50 or system, seeking information regarding amounts owing by that player. In response to an indication of an amount owed, the amount of the jackpot might be reduced by the amounts owing. The remainder of the jackpot amount may then be paid to the player. The deducted amounts, whether for existing tax liability, tax liability associated with the jackpot win, child and/or spousal support, one or more markers, or other obligations, might then be paid or submitted on behalf of the player.

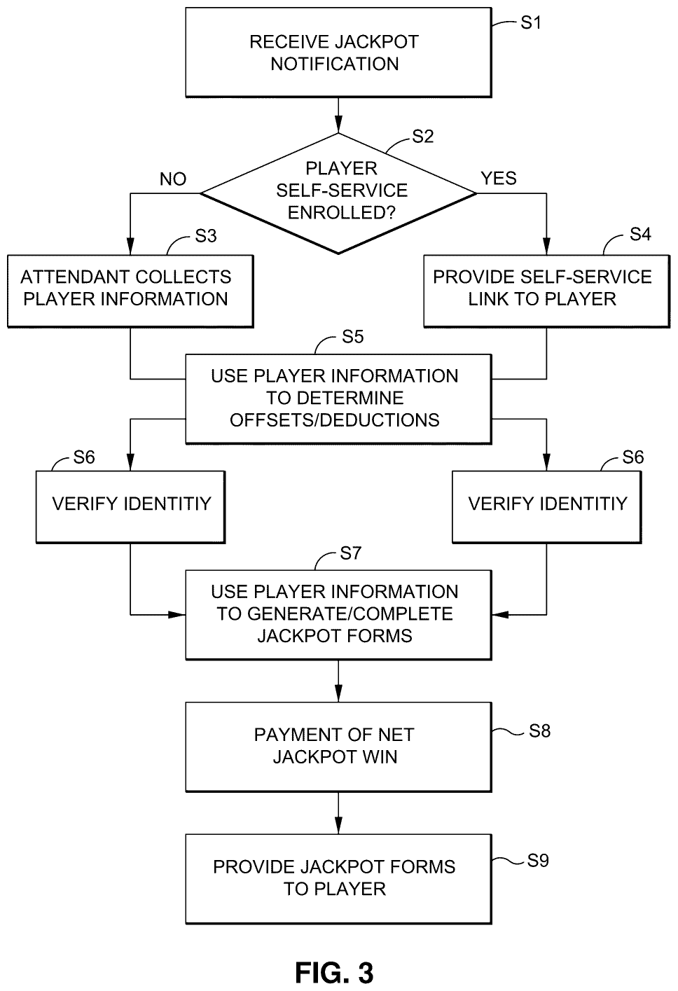

Yet another embodiment of processing a jackpot will be described with reference to FIG. 3. One embodiment of the invention is an electronic, self-service jackpot processing system and method. In one embodiment, a player may enroll (pre-enroll, or enroll at the time of a jackpot event) for self-service jackpot processing. Such enrollment might comprise, for example, receipt of an enrollment acceptance from a player, which acceptance is stored in association with information regarding the player at the financial server 28 (such as in a database or memory associated with the financial server 28). In one embodiment, player may be required to be enrolled in the self-service system in order to utilize self-service processing. In one embodiment, information regarding whether the player is enrolled, as well as contact information for the player' mobile communication device (such as the telephone number thereof), is preferably obtained and stored in association with player identification information, such as in association with a player loyalty or other account, which account may be identified by account login information or the like which is provided by the player.

In response to receiving a notification of a jackpot occurring at a particular gaming machine 22, such as at step S1, and information regarding the player who won the jackpot (such as based upon identity of the player from the player's use of a player loyalty card or ID), the financial server 28 may determine (using the provided player identity information in relation to the stored player information, such as associated with a player account which is linked to the player identity information) whether the player is enrolled in self-service processing, as at step S2. If not, the player might be prompted as to whether they wish to enroll (such as via the gaming machine 22 or a mobile communication device 52 (e.g. phone, PDA, tablet, etc.) of the player).

If the player is not enrolled or does not wish to enroll, the jackpot might be processed in the manner described above, such as where an attendant A uses a mobile device 32 to facilitate the processing of the jackpot, starting at step S3.

If the player is enrolled or does enroll in self-service jackpot processing, then the player may be sent a message, such as a text message or email message sent to their mobile communication device 52, such as at step S4, utilizing the stored mobile communication device contact information. This message may provide instructions and/or a link (such as a website hyperlink which links to a web page supported by the financial server 28, such as an associated webserver). The player may use the instructions, such as by selecting the hyperlink, in order to initiate a jackpot self-service process via their mobile communication device 52. In one embodiment, this may comprise the financial server 28 causing jackpot processing information to be displayed on a display of the player's mobile communication device 52. Advantageously, this jackpot self-service process can occur while the player is still at the gaming machine 22 at which the jackpot was awarded.

In a step S5, the jackpot amount may be adjusted, based upon determined offsets or deductions, such as noted above. In the case of attended processing, the amount of the jackpot and any offsets or deductions, might be displayed to the attendant via their mobile device 32, including for presentation to the player. In the case of self-service processing, such information may be displayed to the player via their mobile communication device 52.

In one embodiment, the player may be required to provide various inputs, such as via their mobile communication device 52 to the financial server 28. These inputs, for example, may comprise the confirmation of various information (the jackpot amount, any offsets or deductions, player information and the like). Further, in one embodiment, the player's identity may be confirmed as part of the self-service process, such as in step S6 (this same step may, as detailed above, be performed by an attendant in the attended version of the processing, as detailed above).

Verification of the player's identity might be confirmed in various manners, such as via use of an authentication application or service, such as which requires the player to use a camera of their mobile communication device 52 to supply one or more photos or videos of themselves, such as for comparison to a stored image, which requires the player to provide an image of their Driver's License or other ID, and/or which requires the player to establish a communication link with an attendant (such as by a communication application such as Zoom™ or Microsoft Teams™, or Apple FaceTime™ or the like), by which the attendant then collects information regarding the player for use in confirming the identity of the player.

The self-service process may also include collecting a signature from the player, such as for one or more tax forms, an acknowledgement or receipt of the jackpot and any amounts offset or deducted, etc. In one embodiment, the player might provide input of a signature via their mobile communication device 52 (such as by touch input to the display thereof) or by selecting a signature acknowledgement or the like (in some cases, during the enrollment process, the player's signature might be collected and thereafter, during jackpot processing, the player might simply provide an approval to associate their existing signature with the one or more forms or the like (as noted above, in an “attended” implementation, the player's signature may be captured by the attendant, such as via their mobile device 32).

The player and jackpot information may then be used by the financial server 28 to generate one or more records (such as jackpot processing records) and jackpot-related forms, including jackpot payment receipts and/or tax forms, such as in step S7.

In a step S8, payment of the net jackpot amount (e.g. the amount of the jackpot win, less any deductions or offsets) may be made to the player.

In a step S9, completed tax or other forms may be provided to the player. Further, completed forms, reports and/or tax withholding amounts might also be submitted to external authorities, such as tax authorities.

The amount of a jackpot which is payable to the player (e.g., the amount of the jackpot less any offsets or deductions) may be processed in various manners. For example, in one embodiment, the net jackpot might be paid by an attendant, such as from a jackpot payment pouch (such as in currency). In another embodiment, a cashless gaming ticket might be generated (such as at the request of the financial server 28 and/or attendant mobile device 32, such as for printing by a printer thereof, or at a kiosk 30, etc., which can be provided to the player and which has a value which represents the net amount of the jackpot). The player might present this ticket to the gaming machine 22 to associate the monetary value with the credit meter thereof (such as by a ticket reader of the gaming machine 22 reading information regarding the ticket and using that information to validate the ticket with a ticketing/accounting server), or by cashing the ticket at a casino cage or other location, etc.

In another configuration, the amount of the net jackpot might be transferred to a wagering account or wallet which is associated with the player (and which might be maintained by the casino C or by another entity, such as a financial provider).

In yet another embodiment, the net jackpot might be transmitted to the gaming machine 22, such as for association with the credit meter thereof. This might be accomplished in various manners. For example, the financial server 28 might communicate with the casino management system/accounting server 23 which communicates with the gaming machines 22, thus permitting this server to instruct the gaming machine 22 to increase the balance of credits.

In other configurations, the net amount of the jackpot might be transmitted to the gaming machine 22 via an interface to the gaming machine 22, which interface may communicate with the controller of the gaming machine 22. Such an interface might comprise, for example, a bill validator or reader, or a secondary interface. Such a bill validator or reader might be configured to read and validate currency and/or printed cashless gaming tickets, but might also be configured to receive information about monetary amounts, such as in the form of a virtual ticket, data regarding a wagering account or wallet or other funds related data, and to then communicate with the controller of the gaming machine 22 to cause the controller to increment the credit meter thereof by the amount of the indicated funds. In other embodiments, the secondary interface might communicate with the controller of the gaming machine 22 via a secondary slot accounting system (SAS) port or other communication interface to the controller, thus again allowing an instruction to be provided to the controller of the gaming machine 22 to increase the credit balance thereof.

While aspects of the invention have been described as being implemented by a financial server 28, such may be referred to by other nomenclature, and may be associated with other element. For example, the invention may be implemented by a jackpot processing system which comprises the financial server 28, one or more webservers and/or other elements.

It is common for a gaming machine to “lock” upon a designed win, such as a win having an associated large award/jackpot. In one embodiment, the jackpot processing system (such as the financial server 28) may be configured to unlock the gaming machine for further play in the event the player is enrolled in self-service jackpot processing and/or when the jackpot processing is complete. This may be accomplished by transmission of an unlock instruct from the jackpot processing system, such as through a casino game management system or directly to the gaming machine.

Aspects of the invention may be applied to online casino environments. For example, one or more wagering games might be presented to players via one or more game servers (not shown). In the event a jackpot winning outcome is received by an online player, the player might process the online jackpot using the process described above, and particularly via a self-service process. This process enables the casino to validate the player relative to the jackpot win, and also to process any offsets or deductions, to process the jackpot related forms, and to provide the forms to the player.

As indicated above, in one embodiment, self-service jackpot processing may be enabled by a web-server configuration, such as facilitated by a browser of the player's mobile communication device 52 running on a processor thereof. However, in other embodiments, the process might be enabled by a processing application which is stored in a memory of the player's mobile device and is executed by a processor thereof, in communication with the financial server 28.

This aspect of the invention solves a large number of problems. For example, self-service jackpot processing reduces the need for costly attendants and the delays in processing a jackpot which result from the casino having to send an attendant to the gaming machine to do the processing. The configuration of the invention also reduces the complexity of the jackpot processing system, such as by eliminating the need for attendant devices. Instead, the casino only needs to run a jackpot processing system and the processing is facilitated by devices of the players. This embodiment of the invention also reduces down-time of a gaming machine because the jackpot processing is expedited, allowing the gaming machine to be unlocked for play by the player without the player having to leave the machine.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for self-service processing of a casino jackpot won by a player, comprising:
a jackpot processing system in communication with at least one casino gaming machine comprising a housing, a processor, at least one video display and at least one input device, the processor configured to present a wagering game via presentation of game information via said at least one video display, said jackpot processing system comprising a processor configured to execute machine readable code, a memory, a communication interface, and machine readable code stored in the memory and executable by the processor;
a database containing player information, said player information comprising mobile communication device contact information for a player and information regarding enrollment of said player in self-service jackpot processing;
said machine readable code of the jackpot processing system configured to cause the processor thereof to, in response to receiving an indication of an occurrence of a designated game win by said player at said casino gaming machine, utilize player identification information to determine, from said player information stored in said database, that said player is enrolled in self-service jackpot processing;
said machine readable code of the jackpot processing system configured to cause the processor thereof to generate jackpot processing information relating to said designated game win, said jackpot processing information comprising at least a payable amount of said designated game win;
said machine readable code of the jackpot processing system configured to cause the processor thereof to generate and transmit a message to a mobile communication device of said player using said mobile communication device contact information;
said machine readable code of the jackpot processing system configured to cause the processor thereof to transmit to said mobile communication device of said player said jackpot processing information in response to a response to said message from said player;
said machine readable code of the jackpot processing system configured to receive one or more inputs from said player via said player's mobile communication device relating to said jackpot processing information, said input comprising at least a signature of said player; and
said machine readable code of the jackpot processing system configured to generate a jackpot record based upon said jackpot processing information and said one or more inputs from said player and generate an approval of payment of said payable amount of said designated game win.

2. The system in accordance with claim 1, wherein said jackpot processing system enables a webserver and said message comprise a hyperlink to said webserver.

3. The system in accordance with claim 1, wherein jackpot processing information is stored at a location designated by said hyperlink.

4. The system in accordance with claim 1, wherein said machine readable code of the jackpot processing system is configured to transmit a request to one or more third party systems regarding amounts owed by said player.

5. The system in accordance with claim 4, wherein said payable amount of said designated game win comprises an award for said game win, less said amounts identified by said one or more third party systems as owed by said player.

6. The system in accordance with claim 1, wherein said machine readable code of the jackpot processing system is further configured to transmit a message to an interface of said casino gaming machine to associate said payable amount to a credit balance at said casino gaming machine.

7. The system in accordance with claim 6, wherein said interface comprises a casino management system which is in communication with said casino gaming machine.

8. The system in accordance with claim 6, wherein said interface comprises an interface to communication port of said gaming machine.

9. The system in accordance with claim 8, wherein said communication port comprises a slot accounting system port.

10. The system in accordance with claim 1, wherein said machine readable code of the jackpot processing system is further configured to cause said processor thereof to transmit a message to a financial system to associate said payable amount with an electronic wallet of said player.

11. The system in accordance with claim 1, wherein said one or more input from said player include a confirmation of said payable amount.

12. The system in accordance with claim 1, wherein said machine readable code of the jackpot processing system is further configured to cause said processor thereof to generate said one or more game win forms and store said game win forms in said database.

13. The system in accordance with claim 11, wherein said machine readable code of the jackpot processing system is further configured to cause said processor thereof to transmit a second message to said player's mobile communication device which provides access to said forms.

14. The system in accordance with claim 1, wherein said player identification information comprises player loyalty account information provided by said player to said casino gaming machine.

15. The system in accordance with claim 1, wherein said one or more player inputs comprise player identity information provided by said player to said mobile communication device.

16. The system in accordance with claim 15, wherein said player identity information comprise an image of at least a portion of said player.

17. The system in accordance with claim 16, wherein said machine readable code of the jackpot processing system is further configured to cause said processor thereof to transmit said image to a third party validation service for validating an identity of said player.
